(19) United States
(12) Patent Application Publication
(10) Pub. No.: US 2010/0128869 A1
(43) Pub. Date: May 27, 2010

(54) METHOD AND DEVICE FOR EXECUTING A CRYPTOGRAPHIC CALCULATION

(75) Inventors: Emmanuelle Dottax, Paris (FR); Herve Chabanne, Mantes La Jolie (FR)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: SAGE, DEFENSE SECURITE, PARIS (FR)

(21) Appl. No.: 11/722,179

(22) PCT Filed: Dec. 22, 2005
(86) PCT No.: PCT/FR2005/003250

§ 371 Date: Feb. 3, 2010

(30) Foreign Application Priority Data
Dec. 22, 2004 (FR) 0413749

(51) Int. Cl. H04L 9/28; H04L 9/00

(52) U.S. Cl. 380/44; 380/28

(57) ABSTRACT

The invention concerns a method which consists in operating a key generation in an electronic component for a specific cryptographic algorithm; storing in the electronic component a prime number P and generating at least a secret prime number. In one step (a) randomly selecting (11) two integers p₁′ et p₂′ the sum of which is equal to a number p′; in a step (b) determining (12) whether the number p′ is a prime number, on the basis of a combination of the prime number stored P with the numbers p₁′ et p₂′, so as to maintain said number p′ secret; in a third step (c), if the number p′ is determined to be a prime number, storing (14) the numbers p₁′ et p₂′ in the electronic component; otherwise repeating steps (a) and (b).

The present invention relates to the field of cryptography and more particularly to protecting the confidentiality of the keys used by cryptographic algorithms.

Cryptographic algorithms make it possible in particular to encrypt data and/or to decrypt data. It is also possible to use such algorithms for numerous other applications. Specifically, they can also serve to sign, or else to authenticate certain information. They can be useful also in the field of time-stamping.

Such algorithms generally comprise a string of several operations, or calculations, that are applied successively to a data item to be encrypted so as to obtain an encrypted data item or else to an encrypted data item so as to obtain a decrypted data item.

Among these algorithms, some are based on using secret keys while others are based on mixed use of public keys and secret keys.

By way of example, the following sections illustrate applications of these algorithms to data encryption and decryption.

According to a general principle of public-key cryptographic algorithms in such applications, the public keys are accessible to all and anyone can dispatch data encrypted with the aid of the public keys; but, only the holder of corresponding secret keys can decrypt these data.

The security of a public-key cryptographic algorithm relies on the fact that knowledge of the public keys does not make it possible to retrieve the corresponding secret keys and therefore it does not make it possible to decrypt the data.

Thus, a public-key encryption procedure, named RSA, standing for Rivest, Shamir, Adelman which are the names of its creators, is known. This procedure is one of the oldest and most used in the field.

According to this procedure, four numbers denoted p, q, e and d are selected. The numbers p and q are two distinct prime numbers. They are generated in a random manner.

The numbers d and e satisfy the following equation: e*d=1 modulo (p−1) (q−1).

It is then possible to use a Euclid algorithm to generate d on the basis of e, p and q, according to calculations that are well known to the person skilled in the art.

Then, the number resulting from the product of the numbers p and q is denoted n (modulus).

Thus, the pair of numbers n and e constitutes the public key while the pair of numbers n and d constitutes a private key.

Then, to dispatch a data item corresponding to an integer M ranging between 0 and n−1, the corresponding coded number C to be dispatched is calculated according to the following equation:

C=M^{e} modulo n

On receipt of the coded message C, the holder of the private key calculates an intermediate value of a number D:

D=C^{d} modulo n

Then, the original plaintext message M is recovered according to the following equation:

D=M^{de}=M modulo n

Thus, in accordance with the foregoing, it is noted that such public-key algorithms are based on the generation of prime numbers. More precisely, public-key algorithms such as RSA may require the generation of very large prime numbers. It may thus be necessary to generate prime numbers comprising nearly 500 digits.

In algorithms of RSA type, it is noted that the modulus n belongs to the public key and can therefore be known to all; while the number d must remain secret in order to guarantee the security of the algorithm. But, the number d is obtained on the basis of the numbers p and q. Consequently, it is important for the security of such algorithms that the numbers p and q remain secret.

Generally, for cryptography software of an electronic card, these keys are generated in an environment protected from any attack, like a factory for example during the manufacture of the electronic component in which the cryptographic algorithm is executed.

Consequently, under such conditions, the numbers p and q can be simply manipulated without any risk of experiencing attacks which would be aimed at determining their value and therefore at destroying the security of the algorithm. Thus, in general, these various methods for generating keys involve the manipulation of these numbers p and q.

Under such conditions, it is possible to use various methods, well known to the person skilled in the art, to generate prime numbers.

However, for certain applications, it may be necessary to generate such keys in exterior environments, in which attacks which are aimed at violating the confidentiality of keys used of the cryptographic algorithm are possible.

Numerous types of attacks are known today.

Thus, certain attacks are based on information leaks detected during the execution of certain cryptographic steps. These attacks are generally based on a correlation between the information leaks detected during the processing by the cryptographic algorithm of the data item and of the key or keys (attacks by analyzing consumption of current, electromagnetic emanations, calculation time, etc.).

Under such conditions, it is fundamental to take suitable precautions to protect the secrecy of the numbers p and q previously entered.

A procedure for generating the numbers p and q which makes it possible to protect the secrecy of these numbers is known. Specifically, an article ‘Efficient Generation of Shared RSA keys’ written by Dan Boneh and Matthew Franklin proposes that the numbers p and q be generated in a simultaneous and confidential manner.

One of the objectives of this procedure is to generate prime numbers in a shared manner between several participants. Thus, these participants execute calculations enabling them to generate two prime numbers without knowing these prime numbers, only the product of these numbers being known by the participants.

According to this procedure, the numbers p and q are selected randomly and simultaneously. Then, it is decided whether the two numbers thus selected are prime numbers on the basis of their product. In order to protect the secret nature of the numbers p and q, these numbers are not manipulated directly.

Specifically, more precisely, four integers, pₐ, p_{b}, qₐ and q_{b} are randomly selected, the number p being the result of the sum of the number pₐ and of the number p_{b}, and the number q being the result of the sum of the number qₐ and of the number q_{b}.

It is then verified whether the numbers p and q are prime numbers on the basis of their product by manipulating the numbers pa, pb, qa and qb.

In the case where the numbers p and q are not prime, the random selection of two other numbers p and q is repeated until the numbers p and q selected are detected as being prime numbers.

Such a solution can be very unwieldy in terms of calculations and may substantially reduce the performance of the methods for generating keys.

The present invention is aimed at proposing a solution which makes it possible to alleviate these drawbacks.

A first aspect of the present invention proposes a method of generating a key for a cryptographic algorithm in an electronic component, in which a prime number P is stored in memory.

The method comprises an operation of generating at least one secret prime number, this operation being carried out according to the following successive steps:

/a/ randomly selecting two integers p₁′ and p₂′ whose sum is equal to a number p′;

/b/ deciding whether said number p′ is a prime number, on the basis of a combining of the prime number stored in memory P with said numbers p₁′ and p₂′;

/c/ if it is decided that the number p′ is a prime number, storing the numbers p₁′ and p₂′ in memory in the electronic component; otherwise repeating steps /a/ and /b/.

By virtue of these arrangements, a prime number p′ can be generated secretly and effectively.

Specifically, the number p′ thus generated is not manipulated directly in the course of the various steps of the method, only the integers p₁′ and p₂′ are manipulated. Consequently, it is not possible to violate the secrecy of the number p′ by attacks of the algorithm in the course of the step of generating this prime number p′.

Furthermore, this prime number generation is effective since it makes it possible to generate several prime numbers successively. But, it is more probable to randomly select a prime number than to randomly select several prime numbers simultaneously, as is proposed in the article ‘Efficient Generation of Shared RSA keys’.

Such a method according to the invention can advantageously be applied to any method of generating a key for a determined cryptographic algorithm in an electronic component, when such an algorithm requires the generation of a secret prime number or even of several secret prime numbers.

Step /b/ can be carried out by implementing any type of primality test making it possible to decide the primality of an integer on the basis of a combining of this integer with a prime number.

In general, such primality tests are probabilistic algorithms. They make it possible to decide that a number is a prime number with a very high probability.

In an embodiment of the present invention, a first integer p₁ and a second integer p₂ are determined so that the prime number P stored in memory is equal to the sum of the determined integers p₁ and p₂. Step /b/ is then implemented on the basis of operations carried out on the numbers p₁, p₂, p₁′ and p₂′.

Thus, in the course of the generation of the secret prime number p′, in the primality test phase for the number p′, preferably, neither the prime number P, nor the number p′ is manipulated, thereby tending to render potential attacks against the secrecy of the number p′ in the course of this generation step in vain.

The first and second integers p₁ and p₂ can be determined in a random manner.

Step /b/ can be carried out with the aid of a primality test based on combining a test of Solovay-Strassen type and a test of Miller-Rabin type. Thus, for example, the primality test can be based on the primality test such as described in the article ‘Efficient Generation of Shared RSA keys’ written by Dan Boneh and Matthew Franklin, in section 3 ‘distributed primality test’. Specifically, this primality test is based on the one hand on a Solovay-Strassen primality test and on the other on a Rabin-Miller primality test. The Solovay-Strassen primality test is described in a document by R. Solovay and V. Strassen “A fast monte carlo test for primality”, 1977. The Rabin-Miller primality test is described in a document by M. Rabin, “Probabilistic algorithm for testing primality”, 1980.

In an embodiment of the present invention, the performance of such a method is enhanced by including before step /b/, the following step:

/a1/ verifying, on the basis of operations carried out on the numbers p₁′ and p₂′, that the number p′ is not divisible by one or more determined prime numbers;

In this case, steps /a/ and /a1/ are repeated if the number p′ is divisible by one of the determined prime numbers.

This step /a1/ is all the more beneficial when one wishes to generate large prime numbers. Specifically, such a step makes it possible to eliminate certain numbers fairly simply, before executing step /b/ which is more unwieldy to carry out.

In an embodiment of the present invention, step /a1/ comprises the following steps, for a prime number y strictly greater than 1:
randomly selecting a first integer c from among the integers ranging between 0 and y−1 and a second integer d from among the integers ranging between 1 and y−1;
determining a number u according to the following equation:

u=c+dp₁′ modulo y;
determining a number v according to the following equation:

v=c−dp₂′ modulo y;
determining whether p is not divisible by y as a function of the difference between the number u and the number v.

Certain cryptographic algorithms require the generation of several secret prime numbers. In this case, it is readily possible to apply a method according to an embodiment of the invention, as many times as necessary to generate a prime number. It is thus possible to generate at least two prime numbers, successively, by repeating steps /a/ to /c/, for construction of a pair of asymmetric keys.

A second aspect of the present invention proposes an electronic component for generating a key for a determined cryptographic algorithm.

The component comprises:
a selection unit suitable for randomly selecting two integers p₁′ and p₂′ whose sum is a number p′;
a memory for storing a prime number P and for storing the numbers p₁′ and p₂′ when it is decided that the sum of said numbers p₁′ and p₂′ is a prime number;
a decision unit suitable for deciding whether the number p′ is a prime number on the basis of a combining of the prime number stored in memory P with said numbers p₁′ and p₂′.

The selection unit can determine a first integer p₁ and a second integer p₂ so that the prime number P stored in memory is equal to the sum of said determined integers p₁ and p₂; and the decision unit can decide whether the number p′ is an integer on the basis of operation carried out on the numbers p₁, p₂, p₁′ and p₂′.

In an embodiment of the present invention, the selection unit determines the first and second integers p₁ and p₂ in a random manner.

The decision unit preferably implements a primality test based on combining a test of Solovay-Strassen type and a test of Miller-Rabin type, such as that proposed in the article ‘Efficient Generation of Shared RSA keys’.

Preferably, the selection unit conducts a prior check, on the basis of operations carried out on the numbers p₁′ and p₂′, in order to verify that the number p′ is not divisible by one or more determined prime numbers.

In this case, the selection unit repeats the random selection of two integers p₁′ and p₂′ if p′ is divisible by a determined prime number.

In an embodiment of the present invention, the selection unit, in order to conduct the prior check in relation to a prime number y strictly greater than 1, furthermore comprises:
means designed to randomly select a first number c from among the integers ranging between 0 and y−1 and a second integer d from among the integers ranging between 1 and y−1;
means designed to determine a number u according to the following equation:

u=c+dp₁′ modulo y;
means designed to determine a number v according to the following equation:

v=c−dp₂′ modulo y;
means designed to determine whether p is not divisible by y as a function of the difference between the number u and the number v.

Other aspects, aims and advantages of the invention will appear on reading the description of one of its embodiments.

The invention will also be better understood with the aid of the figures:

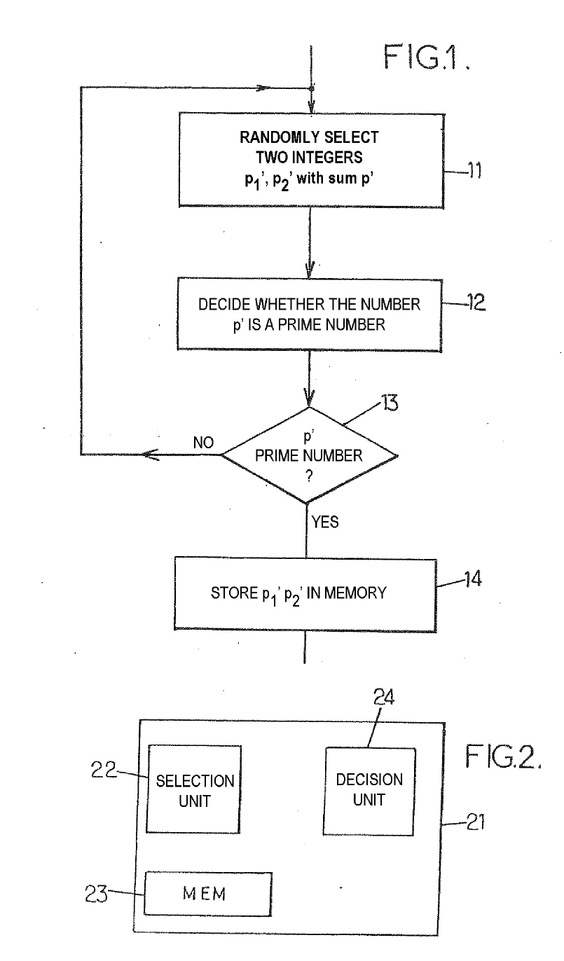

FIG. 1 illustrates the main steps of a method of generating a key according to an embodiment of the present invention;

FIG. 2 is a diagram of an electronic component according to an embodiment of the present invention.

The method of generating a key for a cryptographic algorithm, in an embodiment of the present invention, is intended to be executed in an electronic component.

Previously, the electronic component stores in memory a prime number denoted P.

FIG. 1 illustrates the main steps of the method according to an embodiment of the invention.

In step 11, two integers denoted p₁′ and p₂′ are randomly selected. Then, in step 12, it is decided whether the sum, denoted p′, of these two selected numbers is a prime number. This step is carried out in such a way that the secrecy of the number p′ is protected. Thus, preferably, in this step, care is taken not to manipulate the number p′ as such. The decision on the primality of the number p′ is made by operations performed on the numbers p₁′ and p₂′.

Then, in step 13 if the number p′ is detected as not being a prime number, the previous steps 11 and 12 are repeated.

On the other hand, if it is detected as being a prime number, then the numbers p₁′ and p₂′ are stored in memory.

It is thus possible to repeat such a method each time that the generation of a secret prime number is required.

In step 12, it is possible to implement any primality test which makes it possible to decide whether a number is a combination of two prime numbers, provided that this test does not comprise any operations which might imperil the secret nature of one of the two numbers of the product. Such primality tests are readily available to the person skilled in the art.

Advantageously, these primality tests can make it possible to decide, on the basis of the product n of the prime number P and of the number p′ resulting from the sum of the randomly selected numbers p₁′ and p₂′, whether the number p′ is a prime number. This test therefore comprises operations on the numbers p₁′ and p₂′ but no operations carried out directly on the number p′.

Thus, for example, the primality test can be based on combining a test of Solovay-Strassen type and a test of Miller-Rabin type, such as that proposed in the article ‘Efficient Generation of Shared RSA keys’.

In this case, P is decomposed into the form of two numbers denoted p₁ and p₂. This decomposition can be carried out in a random or non-random manner.

This test makes it possible to decide whether a number m is the product of two prime numbers P and p′, where m satisfies the equation:

m=(p₁+p₂)*(p₁′+p₂′)
where

P=p₁+p₂

and

p′=p₁′+p₂′.

Thus, without having to manipulate the numbers P and p′ directly, it is possible to decide whether these numbers P and p′ are prime numbers.

It is noted that, in such an application the number m can be manipulated without risk since it is not secret.

As is described in detail in the article ‘Efficient Generation of Shared RSA keys’, it is assumed, in this test, that the various numbers satisfy the following characteristics:

p₁=3 mod 4

and

p₁′=3 mod 4

then

p₂=0 mod 4

and

p₂′=0 mod 4

In order not to allow any attack as regards secrecy on the number p′, in the course of this step, the operations are advantageously carried out on the numbers p₁, p₂, p₁′ and p₂′.

Firstly, a number a is selected in a random manner from among the integers ranging between 1 and m−1.

The Jacobi symbol relating to the number a thus selected, denoted a/m, is calculated thereafter.

Then, if the Jacobi symbol thus calculated is different from 1, the random selection step for the number a is repeated.

If the Jacobi symbol is equal to 1, we continue with the following step.

A first intermediate calculation is then performed on the numbers m, p₁ and p₂′ and a number u is obtained satisfying the following equation:

$$u = a \frac{m - {p}_{1} - {p}_{1}^{′} + 1}{4} mod m$$

Thereafter, a second intermediate calculation is performed on the numbers m, p₁ and p₂, and a number v is obtained satisfying the following equation:

$$v = a \frac{{p}_{2} + {p}_{2}^{′}}{4} mod m$$

A test is then carried out as to whether the following equation is satisfied:

u=+/−v mod m

If the latter equation is satisfied, it is deduced therefrom that m is the product of the two integers P and p′ with a certain probability.

In an embodiment of the present invention, P is a prime number stored beforehand in a memory of the electronic component. Consequently, by applying this type of test, it is possible to decide whether the number p′ is a prime number without having performed any operation directly on the number p′.

In an embodiment of the present invention, to increase the probability of carrying out step 12 on numbers p₁′ and p₂′ whose sum is an integer, it is possible to carry out, before step 12, a step which makes it possible to eliminate beforehand, in a simple and effective manner, certain numbers.

It is thus possible to consider a set of prime numbers. Then, before step 12, one wishes to determine whether the number p′ is divisible by a prime number denoted y. For this purpose, an integer c is randomly selected from among the integers ranging between 0 and y−1 and an integer d is randomly selected from among the integers ranging between 1 and y−1.

Then, the following two intermediate calculations are performed:

u=c+dp₁′ modulo y

v=c−dp₂′ modulo y

It is then possible to test whether the following equation is satisfied:

u−v=0 modulo y

When the latter equation is satisfied, it is deduced therefrom that the number p′ is divisible by y.

FIG. 2 is a diagram representing an electronic component according to an embodiment of the present invention.

Such a component 21 comprises a selection unit 22 suitable for randomly selecting two integers p₁′ and p₂′ whose sum is a number p′.

It furthermore comprises a memory 23 for storing a prime number P and for storing the numbers p₁′ and p₂′ when it is decided that the sum of these numbers p₁′ and p₂′ is a prime number.

It also comprises a decision unit suitable for deciding whether the number p′ is a prime number on the basis of a combining of the prime number stored in memory P with the numbers p₁′ and p₂′.

A method of generating a key suitable for generating in an effective and secret manner a prime number or several prime numbers in a successive manner is thus obtained.

1. A method of generating a key for a cryptographic algorithm in an electronic component (21);
according to which a prime number P is stored in memory in said electronic component;
said method comprising an operation of generating at least one secret prime number, said operation being carried out according to the following successive steps:
/a/ randomly selecting (11) two integers p₁′ and p₂′ whose sum is equal to a number p′;
/b/ deciding (12) whether said number p′ is a prime number, on the basis of a combining of the prime number stored in memory P with said numbers p₁′ and p₂′;
/c/ if it is decided that the number p′ is a prime number, storing (14) the numbers p₁′ and p₂′ in memory in the electronic component; otherwise repeating steps /a/ and /b/.

2. The method as claimed in claim 1, according to which a first integer p₁ and a second integer p₂ are determined so that the prime number P stored in memory is equal to the sum of said determined integers p₁ and p₂; and
according to which step /b/ is implemented on the basis of operations carried out on the numbers p₁, p₂, p₁′ and p₂′.

3. The method as claimed in any one of the preceding claims, according to which the first and second integers p₁ and p₂ are determined in a random manner.

4. The method as claimed in any one of the preceding claims, according to which step /b/ is carried out with the aid of a primality test based on combining a test of Solovay-Strassen type and a test of Miller-Rabin type.

5. The method as claimed in any one of the preceding claims, furthermore comprising, before step /b/, the following step:
/a1/ verifying, on the basis of operations carried out on the numbers p₁′ and p₂′, that the number p′ is not divisible by one or more determined prime numbers; according to which steps /a/ and /a1/ are repeated if the number p′ is divisible by one of said determined prime numbers.

6. The method as claimed in claim 5, according to which step /a1/ comprises the following steps, for a determined prime number y strictly greater than 1:
randomly selecting a first number c and a second number d from among the integers ranging between 1 and y−1;
determining a number u according to the following equation:
u=c+dp₁′ modulo y;
determining a number v according to the following equation:
v=c−dp₂′ modulo y;
determining whether p is not divisible by y as a function of the difference between the number u and the number v.

7. The method as claimed in any one of the preceding claims, according to which at least two prime numbers are generated by repeating steps /a/ to /c/ for construction of a pair of asymmetric keys.

8. The method as claimed in any one of the preceding claims, according to which the cryptography algorithm is an algorithm of RSA type.

9. An electronic component (21) for generating a key for a determined cryptographic algorithm;
said component comprising:
a selection unit (22) suitable for randomly selecting two integers p₁′ and p₂′ whose sum is a number p′;
a memory (23) for storing a prime number P and for storing the numbers p₁′ and p₂′ when it is decided that the sum of said numbers p₁′ and p₂′ is a prime number;
a decision unit (24) suitable for deciding whether the number p′ is a prime number on the basis of a combining of the prime number stored in memory P with said numbers p₁′ and p₂′.

10. The electronic component as claimed in claim 9, in which the selection unit (22) determines a first integer p₁ and a second integer p₂ so that the prime number P stored in memory (23) is equal to the sum of said determined integers p₁ and p₂; and in which the decision unit (23) decides whether the number p′ is an integer on the basis of operations carried out on the numbers p₁, p₂. p₁′ and p₂′.

11. The electronic component as claimed in claim 10, in which the selection unit (22) determines the first and second integers p₁ and p₂ in a random manner.

12. The electronic component as claimed in any one of claims 9 to 11, in which the decision unit (23) implements a primality test based on combining a test of Solovay-Strassen type and a test of Miller-Rabin type.

13. The electronic component as claimed in any one of claims 9 to 12, in which the selection unit (22) conducts a prior check, on the basis of operations carried out on the numbers p₁′ and p₂′, in order to verify that the number p′ is not divisible by one or more determined prime numbers; and
in which the selection unit (22) repeats the random selection of two integers p₁′ and p₂′ if p′ is divisible by a determined prime number.

14. The electronic component as claimed in any one of claims 9 to 13, in which the selection unit (22), in order to conduct the prior check in relation to a prime number y strictly greater than 1, furthermore comprises:
means designed to randomly select a first number c and a second number d from among the integers ranging between 1 and y−1;
means designed to determine a number u according to the following equation:
u=c+dp₁′ modulo y;
means designed to determine a number v according to the following equation:
v=c−dp₂′ modulo y;
means designed to determine whether p is not divisible by y as a function of the difference between the number u and the number v.

15. The electronic component as claimed in any one of claims 9 to 14, in which a plurality of prime numbers p′ is successively generated.

16. The electronic component as claimed in any one of claims 9 to 15, in which the cryptographic algorithm is an algorithm of RSA type.
